(19) United States
(12) Patent Application Publication
(10) Pub. No.: US 2005/0107139 A1
(43) Pub. Date: May 19, 2005

(54) Cellular phone and hinged cover structure thereof

(76) Inventor: Long-Jyh Pan, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/889,388

(22) Filed: Jul. 12, 2004

(30) Foreign Application Priority Data
Nov. 13, 2003 (TW) 92131762

(51) Int. Cl. H04M 1/00

(52) U.S. Cl. 455/575.3; 455/575.1

(57) ABSTRACT

A cellular phone and a hinged cover structure thereof. The hinged cover structure includes a first body, a second body, a sliding member and an elastic member. The first body has a first positioning device, and the second body is rotatably hinged to the first body. The sliding member is disposed in a position where the cover hinged to the main body, movably along a sliding direction, and has a second positioning device. The elastic member has a first end fixed to the sliding member and a second end. When the sliding member moves to a predetermined position, the first and second positioning devices are disengaged and the elastic member drives the sliding member to rotate so that the second body rotates relative to the first body. When the second body rotates to a predetermined angle, the first and second positioning devices are engaged, fixing the second body therein.

### BACKGROUND OF THE INVENTION

1. Field of the Invention

The present invention relates to a hinged cover structure, and particularly to a hinged cover structure of a cellular phone.

2. Description of the Related Art

Generally, a cellular phone can have an integral structure or a hinged cover structure. The body of a cellular phone comprising a hinged cover is at least partially concealed by the cover. To place or receive a call using the cellular phone, the hinged cover thereof must be opened, and then closed when the call is finished. The hinged cover serves to protect the phone from damage due to collision or impact. The hinged cover can additionally be designed to enhance the aesthetic appearance of the cellular phone.

Conventionally, however, a cellular phone must be manually opened. That is, the hinged cover must be manually opened and closed. Manual operation may be considered inconvenient particularly when attempting to open the cover of the phone while holding other items.

### SUMMARY OF THE INVENTION

Accordingly, an object of the present invention is to provide a hinged cover structure, which can be automatically opened by pressing one part of the hinge structure. The hinged cover structure is applicable to a cellular phone comprising a hinged cover or other electronic devices utilizing a hinged cover.

The present invention discloses a hinged cover structure for a cellular phone. The hinged cover structure includes a first body, a second body, a sliding member and an elastic member. The first body is the main body of the cellular phone, comprising a first positioning device. The second body serves as a hinged cover of the cellular phone, and is rotatably hinged to the first body. The sliding member is disposed movably along a sliding direction in the pivot position and has a second positioning device. The elastic member has a first end fixed to the sliding member and a second end. When the sliding member moves to a predetermined position, the first and second positioning devices are released from each other and the elastic member drives the sliding member to rotate so that the second body rotates relative to the first body. When the second body rotates to a predetermined angle relative to the first body, the first and second positioning devices are engaged, positioning the second body at the predetermined angle.

In the hinged cover structure of the present invention, the first positioning device can preferably be a protrusion and the second positioning device can be at least one guiding groove oblique to the sliding direction of the sliding member. Thus, the protrusion detachably engages with the guiding groove according to the movement of the sliding member. Preferably, the sliding member comprises a drive shaft connected to the second body, and the drive shaft has a leading end. The second body may have a bush detachably sleeved to the leading end of the drive shaft, and the bush and the leading end both have a noncircular cross-section.

Additionally, the first body preferably comprises a tunnel with the elastic member disposed therein, the second end of the elastic member and the tunnel each have a noncircular cross-section, and the noncircular cross-section of the second end is defined by the noncircular cross-section of the tunnel.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a disassembled perspective view of the hinged cover structure of the present invention;

FIG. 2A is a perspective view of the main body 10 of FIG. 1;

FIG. 2B is a perspective view of the tunnel 12 of the main body 10 in FIG. 2A;

FIG. 3A is a perspective view of the hinged cover 20 of the embodiment in FIG. 1;

FIG. 3B is a perspective view of the hollow jacket 22 of the hinged cover 20 in FIG. 3A;

FIG. 4A is a perspective view illustrating assembly of the sliding member 30 and the elastic member 40 of the embodiment in FIG. 1;

FIG. 4B is a disassembled perspective view of the sliding member 30 and the elastic member 40 in FIG. 4A;

FIG. 5A is a cross-section of the hinged cover structure when the hinged cover 20 is closed;

FIG. 5B is a cross-section of the hinged cover structure with the button 50 engaged; and

FIG. 5C is a perspective view of the positioning disk 32 of the sliding member 30 of FIG. 1.

### DETAILED DESCRIPTION OF THE INVENTION

The present invention discloses a hinged cover structure, which is applicable to a cellular phone comprising a hinged cover or other electronic devices utilizing a hinged cover. The hinged cover structure in a cellular phone is hereinafter described in detail. It should be mentioned that the hinged cover structure of the present invention is not limited by the description and can be applied in other hinged cover type electronic devices.

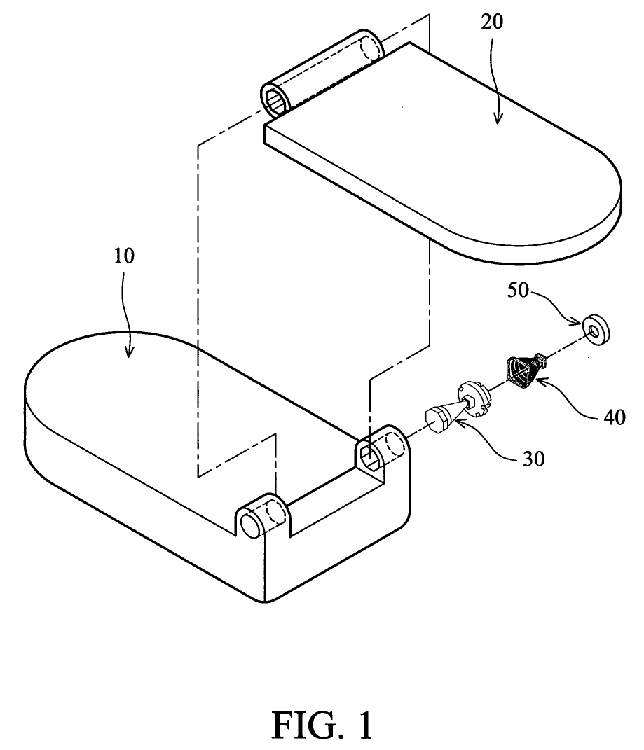

The hinged cover structure of the embodiment is applied in a cellular phone as shown in FIG. 1. The cellular phone has a main body 10 (the first body of the hinged cover structure), a hinged cover 20 (the second body of the hinged cover structure), a sliding member 30, an elastic member 40, and a button 50 disposed on the main body 10.

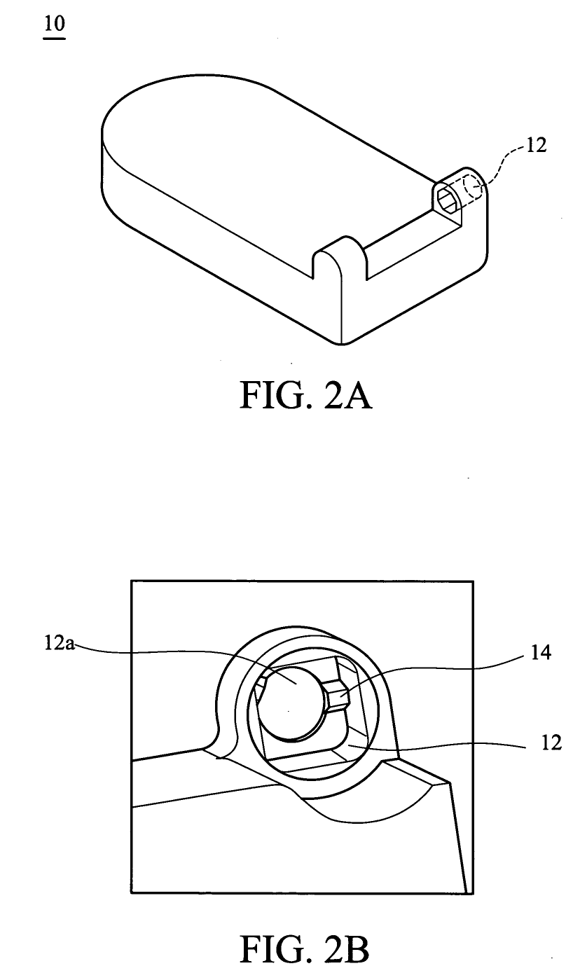

The main body 10, as the first body of the hinged cover structure, provides operational elements such as a keypad for the cellular phone. As shown in FIG. 2A, the main body 10 has a tunnel 12 for receiving the elastic member 40 and the sliding member 30. The cross-section of the tunnel 12 is noncircular, e.g. the quadrangular cross-section as shown in FIG. 2B, to limit rotation of the elements (i.e. the elastic member 40) disposed therein. An opening 12a for the button 50 is provided. Further, the main body 10 comprises a protrusion 14 as a first positioning device.

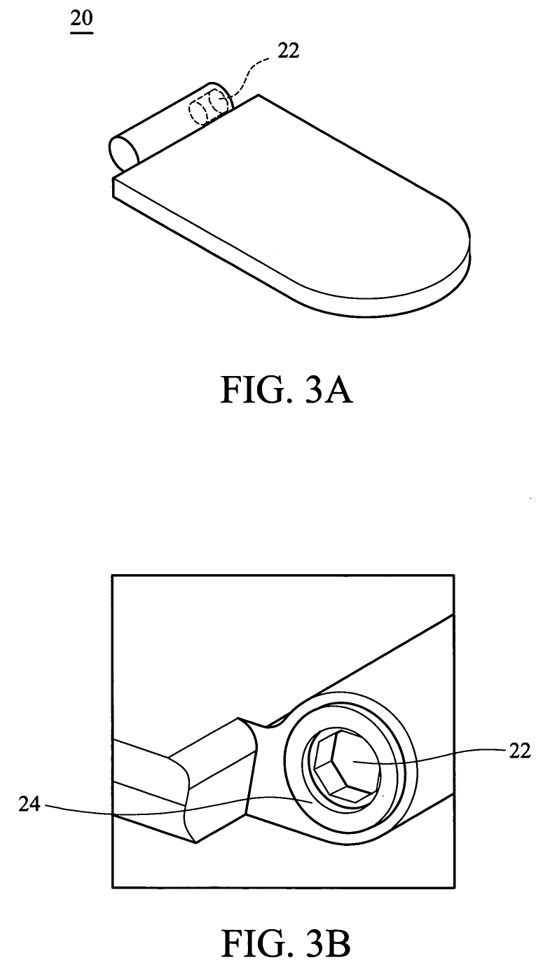

The hinged cover 20, serving as the second body of the hinged cover structure, is rotatably hinged to the main body 10. As shown in FIG. 3A, the hinged cover 20 has a bush 22 in the position corresponding to the pivot position of the main body 10. The cross-section of the bush 22 is also noncircular, e.g. an octagonal cross-section in FIG. 3B, to limit rotation of the elements (i.e. the drive shaft 34) disposed in the bush 22.

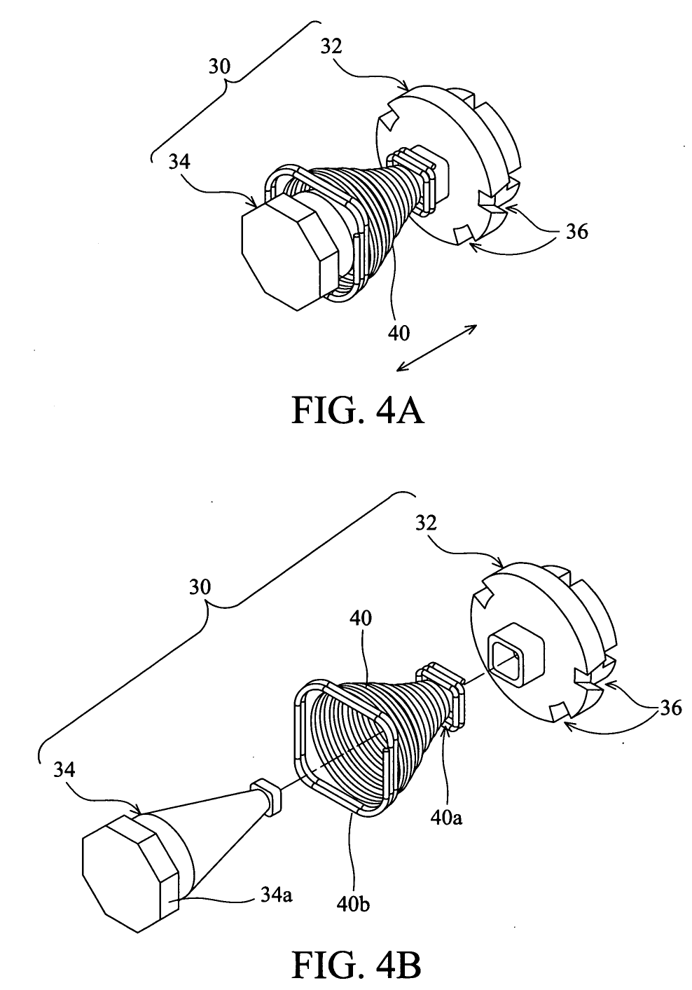

The sliding member 30 and the elastic member 40 are assembled and disposed in a position where the cover 20 hinged to the main body 10, i.e. the tunnel 12 of the main body 10 and the bush 22 of the hinged cover 20. FIG. 4A and FIG. 4B shows the structure of the sliding member 30 and the elastic member 40.

The sliding member 30 comprises a positioning disk 32 serving as a second positioning device, engaging a drive shaft 34. The drive shaft 34 comprises a leading end 34a disposed in the bush 22 such that the drive shaft is connected to the hinged cover 20. The positioning disk 32 has at least one guiding groove 36 oblique to a sliding direction of the sliding member 30, as shown by the arrows in FIG. 4A. Further, the positioning disk 32 is connected to the button 50. Since the positioning s disk 32 and the drive shaft 34 are engaged to each other, the positioning disk 32 and the drive shaft 34 are movable along the sliding direction.

The elastic member 40 is a torsion spring and disposed in the tunnel 12 of the main body 10. The elastic member 40 has a first end 40a fixed to the positioning disk 32 of the sliding member 30, and a second end 40b against an extrusion 24 of the hinged cover 20, such that the elastic member 40 is held in place by elastic force. It is noted that the cross-section of the second end 40b is also noncircular, e.g. the quadrangular cross-section as shown in FIG. 4B, and shape of the cross-section of the second end 40b is defined by the noncircular cross-section of the tunnel 12.

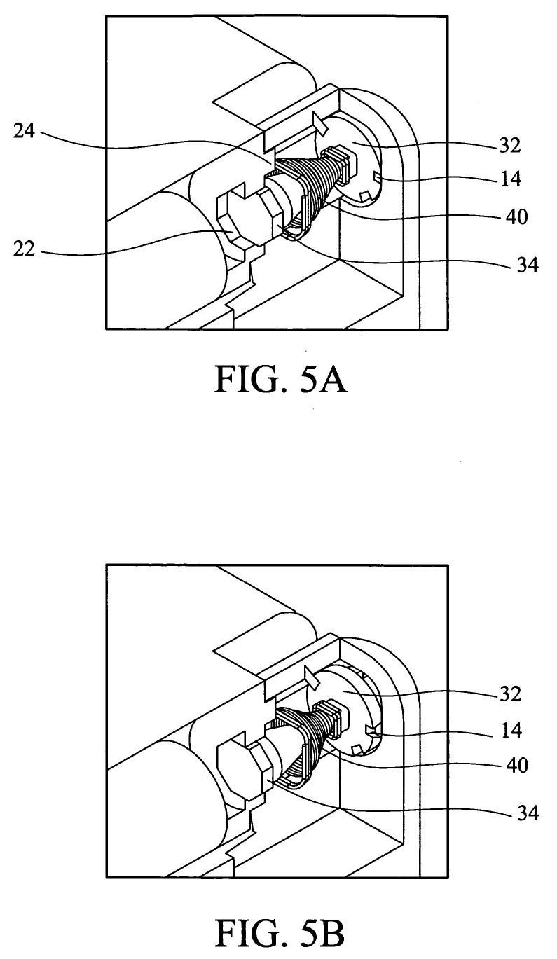

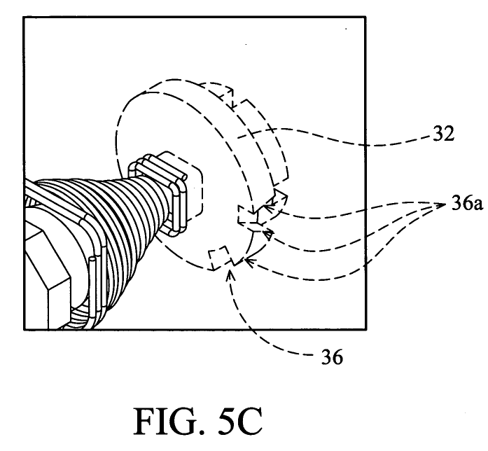

Operation of the cellular phone in the embodiment can be further described with reference to FIG. 5A, FIG. 5B and FIG. 5C.

When the hinged cover 20 is closed, the sliding member 30 and the elastic member 40 are configured as shown in FIG. 5A. The protrusion 14 (i.e. the first positioning device) of the main body 10 is engaged with a guiding groove 36 of the positioning disk 32 (i.e. the second positioning device) of the sliding member 30 to keep the hinged cover 20 closed. Further, the elastic member 40 is under torque, storing preliminary elastic energy.

When the button 50 is pushed, that is, when the positioning disk 32 is pushed, the sliding member 30 moves along the sliding direction toward a predetermined position as shown in FIG. 5B. In this case, the guiding groove 36 of the positioning disk 32 and the protrusion 14 of the main body 10 are released from each other, and the elastic energy stored in the elastic member 40 is released such that the elastic member 40 drives the sliding member 30 to rotate. Since the hinged cover 20 engages the drive shaft 34 of the sliding member 30, the hinged cover 20 rotates along with the sliding member 30 to perform the unfolding action.

Further, when the hinged cover 20 rotates to a predetermined angle relative to the main body 10, the sliding member 30 slides to a position in which the protrusion 14 engages another guiding groove 36 of the positioning disk 32. Thus, the hinged cover 20 is positioned at a predetermined angle relative to the main body 10.

The hinged cover 20 can be manually closed without pressing the button 50 or pressing the positioning disk 32. The guiding groove 36 preferably has an oblique surface 36a, oblique to the sliding direction of the sliding member 30, as shown in FIG. 5C. Thus, the guiding groove 36 easily drives the positioning disk 32 to move inward along the oblique surface 36a to disengage from the protrusion 14.

Further, the user can manually unfold the hinged cover 20 without pushing the button 50 or without pushing the positioning disk 32. In this case, the guiding groove 36 easily drives the positioning disk 32 to move inward along the oblique surface 36a to disengage from the protrusion 14.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A hinged cover structure, comprising:
a first body having a first positioning device;
a second body rotatably hinged to the first body;
a sliding member disposed in a position where the second body hinged to the first body, movably along a sliding direction, the sliding member having a second positioning device; and
an elastic member having a first end fixed to the sliding member and a second end;
when the sliding member moves to a predetermined position, the first positioning device and the second positioning device are disengaged and the elastic member drives the sliding member to rotate so that the second body rotates relative to the first body;
when the second body rotates to a predetermined angle relative to the first body, the first positioning device and the second positioning device are engaged, fixing the second body to the first body.

2. The hinged cover structure as claimed in claim 1, wherein the first positioning device comprises a protrusion and the second positioning device comprises at least one guiding groove oblique to the sliding direction of the sliding member, the protrusion detachably engaged to the guiding groove according to the movement of the sliding member.

3. The hinged cover structure as claimed in claim 1, wherein the sliding member further comprises a drive shaft connected to the second body, and the drive shaft has a leading end.

4. The hinged cover structure as claimed in claim 3, wherein the second body comprises a bush detachably accommodating the leading end of the drive shaft, the bush and the leading end having noncircular cross-sections.

5. The hinged cover structure as claimed in claim 1, wherein the first -body has a tunnel for the elastic member to be disposed therein, cross-sections of the second end of the elastic member and the tunnel being noncircular, and shape of cross-section of the second end is defined by the noncircular cross-section of the tunnel.

6. The hinged cover structure as claimed in claim 1, wherein the second body has an extrusion, the second end of the elastic member being against the extrusion.

7. A cellular phone, comprising:
a main body having a first positioning device;
a hinged cover rotatably hinged to the main body;
a sliding member disposed in a position where the cover hinged to the main body, movably along a sliding direction, the sliding member having a second positioning device; and
an elastic member having a first end fixed to the sliding member and a second end;
when the sliding member moves to a predetermined position, the first positioning device and the second positioning device are disengaged and the elastic member drives the sliding member to rotate so that the hinged cover rotates relative to the main body;
when the hinged cover rotates to a predetermined angle relative to the main body, the first positioning device and the second positioning device are engaged, fixing the hinged cover to the main body.

8. The cellular phone as claimed in claim 7, wherein the first positioning device comprises a protrusion and the second positioning device comprises at least one guiding groove oblique to the sliding direction of the sliding member, the protrusion detachably engaged to the guiding groove according to the movement of the sliding member.

9. The cellular phone as claimed in claim 7, wherein the sliding member further comprises a drive shaft connected to the hinged cover, and the drive shaft has a leading end.

10. The cellular phone as claimed in claim 9, wherein the hinged cover has a bush detachably accommodating the leading end of the drive shaft, the bush and the leading end having noncircular cross-sections.

11. The cellular phone as claimed in claim 7, wherein the main body has a tunnel for the elastic member to be disposed therein, cross-sections of the second end of the elastic member and the tunnel being noncircular, and shape of cross-section of the second end is defined by the noncircular cross-section of the tunnel.

12. The cellular phone as claimed in claim 7, wherein the second body has an extrusion, the second end of the elastic member being against the extrusion.

13. The cellular phone as claimed in claim 7, further comprising a button disposed in a hole of the main body to connect to the sliding member.
